(19) United States
(12) Patent Application Publication
(10) Pub. No.: US 2012/0036262 A1
(43) Pub. Date: Feb. 9, 2012

(54) SYSTEM AND METHOD OF RESOURCE REPLICATION DELIVERY TO MULTIPLE LOCAL DESTINATIONS

(76) Inventors: William A. MURPHY, Glace Bay (CA); Gordon FREEDMAN, Ottawa (CA)

(21) Appl. No.: 13/198,271

(22) Filed: Aug. 4, 2011

Related U.S. Application Data
(60) Provisional application No. 61/370,848, filed on Aug. 5, 2010.

(51) Int. Cl. G06F 15/173

(52) U.S. Cl. 709/225

(57) ABSTRACT

A system and method are provided for streaming resource replication, registration and delivery. A nonlocal streaming resource is replicated in a local network as a local multicast resource. The local multicast source is registered on a resource management server with an entry which identifies the nonlocal resource and contains information for use in locally accessing the local multicast resource. When a local client of the local network requests access to the local multicast resource, the resource management server determines that the local client and the local multicast source are local to each other and provides a response for enabling direct local access by the local client to the local multicast resource.

This application claims the benefit of U.S. Provisional Patent Application No. 61/370,848, filed on Aug. 5, 2010, the entire contents of which are incorporated herein by reference.

### FIELD OF THE INVENTION

The invention relates to communications networks, and more particularly to streaming resource replication, registration, and delivery.

### BACKGROUND OF THE INVENTION

In network communication systems delivery of resources and or services from a source machine to one or more client destinations requires a host of network infrastructure to ensure proper delivery of the resource when requested by the clients. One type of network resource which can be bandwidth intensive and require special considerations is streaming media. Streaming video and sound require real-time transfer of data such that an uninterrupted quality of presentation is provided. Some systems and applications by their nature require efficient and reliable delivery of real-time streaming media, two examples of which are systems for surveillance and security and live streaming webcam services. When multiple clients request the same streaming network resource through the network, performance of the network to deliver the requested resource must scale with the number of clients in order to ensure uncompromised delivery.

Modern security and surveillance systems have come to rely very heavily on the use of video surveillance cameras for the monitoring of remote locations, entry/exit points of buildings or other restricted areas, and high-value assets, etc. The majority of surveillance video cameras has been changing from analog cameras used in closed circuit television (CCTV) based systems to digital cameras used in today's digital video systems (DVS). In DVS, video is digitized, compressed and packetized in IP, and then streamed to a server. Recently, IP-networked digital video systems have been implemented. In this type of system the surveillance video is encoded directly on a digital camera, in H.264 or another suitable standard for video compression, and is sent over Ethernet at a lower bit rate. This transition from analog to digital video is bringing about long-awaited benefits to security and surveillance systems, largely because digital compression allows more video data to be transmitted and stored. Of course, a predictable result of capturing larger amounts of video data is that more personnel are required to review the video that is provided from the video surveillance cameras. Advantageously, storing the video can reduce the amount of video data that is to be reviewed, since the motion vectors and detectors that are used in compression can be used to eliminate those frames with no significant activity. This compressed video data can be sent directly to one or more security personnel for review or may first be subject to what is known as video analytics which further electronically recognizes important activity recorded within the video data and forwards data reflecting the same further down the processing/delivery path between the original video source and the data's final destination.

Other streaming video resources are available on the internet and may be accessed with web browsers and systems which are capable of retrieving and displaying live video streams. These other streaming video resources may be provided directly from webcams or may originate with any other broadcast or multicast video streaming service where streaming access is provided around the clock or during specific special occasions. Streaming services set-up for security, traffic monitoring, weather monitoring, scientific observation, sporting events, entertainment events, and community events are all examples of the kinds of video streaming services which may be provided to multiple viewers at the same time.

Regardless of the particular kinds of video data processing that are employed and where they are carried out, regardless of the size and nature of the streaming video data, and regardless of the degree of video analytics carried out on the video data or the location where this occurs, there must exist a system and method for delivering the data resource to multiple destinations.

FIG. 1 illustrates an example of a known system for generic resource delivery to multiple client destinations. The multiple client destinations include multiple local client destinations 146, 147, 148 which are connected to a local network 145 within a local infrastructure 140, and a nonlocal client 112 which is connected to a large public network 110 such as the Internet. For access by the local network 145 to outside networks, local gateway infrastructure 141 is used. The local gateway infrastructure 141 is connected by an Internet service provider (ISP) infrastructure 120 to the large public network 110. A nonlocal server 111 is the originator of the streaming video data which is to be delivered, and may be in the form of a digital video camera.

Data files, services, streaming services and other resources delivered across networks are commonly accessed using web browsers. In the known system 100, the local clients 146, 147, 148 and the nonlocal client 112 are running web browsing applications which are displaying a webpage including a video player or viewer for displaying the streaming video resource DATA A. Utilizing a URL (Universal resource locator), IP address or other addressing system, the web browsing applications running on the local and nonlocal clients 146, 147, 148, 112 accesses the streaming video resource DATA A provided by the nonlocal server 111 through the large public network 110, and in the case of the local clients, also through the ISP infrastructure 120, the local gateway infrastructure 141 and the local network 145. In the system shown in FIG. 1, DATA A is most commonly provided to multiple clients such as the nonlocal client 112 (CLIENT 4) and the first, second, and third client 146, 147, and 148 using a multicasting protocol.

It is clear that during provision of DATA A to the local clients 146, 147, 148, of the known system 100, bandwidth and resources of both the local gateway infrastructure 141 and the ISP infrastructure 120 are utilized at a level which scales with the number of local clients receiving the streaming video resource DATA A. In order to service three copies of DATA A being streamed to three clients in the local infrastructure 140, the ISP infrastructure 120 which serves the local infrastructure must handle three times the bandwidth required for a single stream of DATA A while in order to service the three copies of DATA A within the local infrastructure 140, the local gateway infrastructure 141 must also handle three times the bandwidth required for a single stream of DATA A.

The known system described above utilizes resources external and internal to a local network when providing access to multiple copies of the data or resources requested by multiple local clients in a multicast configuration. This causes undesirable delay, needless cost, and needless use of hardware recourses since the data or resource requested by the plurality of local clients is identical.

### SUMMARY OF THE INVENTION

According to one aspect, the invention provides for a method of providing access to a nonlocal streaming resource within a local network, the method comprising: receiving the nonlocal streaming resource at a local server in the local network; replicating the nonlocal streaming resource and forming a local multicast source of the nonlocal streaming resource; registering the local multicast source on a resource management server, generating a registration; receiving at the resource management server a plurality of requests for the nonlocal streaming resource from a corresponding plurality of local clients of the local network; determining that the local multicast source corresponds to the nonlocal streaming resource of the plurality of requests with use of the registration; determining that the local multicast source is local to the plurality of local clients; and providing to the plurality of local clients, local access to the local multicast source.

According to another aspect, the invention provides for a method wherein local access comprises access only through the local network.

According to another aspect, the invention provides for a method wherein the registration comprises a unique identifier for identifying the nonlocal streaming resource.

According to another aspect, the invention provides for a method wherein the registration comprises one of an address and locator information of the local multicast source for providing local access by the plurality of local clients to the local multicast source.

According to another aspect, the invention provides for a method wherein forming the local multicast source comprises creating a local IP multicast source for the nonlocal streaming resource.

According to another aspect, the invention provides for a method wherein registering the local multicast source comprises: receiving at the resource management server the unique identifier of the nonlocal streaming resource in a resource register message; and storing the unique identifier in an entry of a registry.

According to another aspect, the invention provides for a method wherein the one of an address and locator information of the local multicast source is explicit, and wherein registering the local multicast source further comprises storing the one of an address and locator information of the local multicast source in the registration with the unique identifier of the nonlocal streaming resource.

According to another aspect, the invention provides for a method wherein determining that the local multicast source corresponds to the nonlocal streaming resource of the plurality of requests with use of the registration comprises comparing unique identifiers of entries in the registry with information in the plurality of requests identifying the nonlocal streaming resource.

According to another aspect, the invention provides for a method wherein determining that the local multicast source is local to the plurality of local clients comprises comparing one of an implicit address and implicit locator information contained within communication signals of the local multicast source with a corresponding one of an implicit address and implicit locator information contained within communication signals from the plurality of local clients.

According to another aspect, the invention provides for a method wherein providing to the plurality of local clients, local access to the local multicast source comprises sending a plurality of local redirection messages from the resource management server to the plurality of local clients wherein each of the local redirection messages comprise information sufficient to enable local access to the local multicast source by each of the plurality of local clients.

According to another aspect, the invention provides for a method wherein each of the local redirection messages comprises at least one of an explicit address and explicit locator information which enables local access to the local multicast source.

According to another aspect, the invention provides for a method wherein the nonlocal streaming resource comprises streaming media.

According to another aspect, the invention provides for a method for reducing a bandwidth and storage consumed in a process of managing video, wherein the local network comprises a corporate network, wherein the process of managing video is carried out on the corporate network, and wherein the nonlocal streaming resource comprises video managed by the process of managing video.

According to another aspect, the invention provides for a method wherein at least one of the plurality of local clients comprises a security application and the nonlocal streaming resource comprises a security video stream for use by the security application.

According to another aspect, the invention provides for a method for at least one of re-purposing and multi-purposing the nonlocal streaming resource in the form of a camera stream, wherein the local network comprises a corporate network, wherein the camera stream is used for a primary purpose, and wherein at least one local client of the plurality of local clients utilizes the camera stream for a secondary purpose different from the primary purpose.

According to another aspect, the invention provides for a method wherein said local access comprises delayed access.

According to another aspect, the invention provides for a method wherein the local server stores a local copy of the nonlocal streaming resource.

According to another aspect, the invention provides for a system for providing access to a nonlocal streaming resource within a local network, the system comprising: a local server in the local network for receiving the nonlocal streaming resource, for replicating the nonlocal streaming resource, and for forming a local multicast source of the nonlocal streaming resource; a resource management server for registering the local multicast source thereby generating a registration and for receiving a plurality of requests for the nonlocal streaming resource from a plurality of local clients of the local network, the resource management server comprising: a registry for storing the registration; and a registration and redirection module for determining that the local multicast source corresponds to the nonlocal streaming resource of the plurality of requests with use of the registration, and for determining that the local multicast source is local to the plurality of local clients, wherein the resource management server is for, once the registration and redirection module determines that the request is for the nonlocal streaming resource corresponding to the local multicast source and that the local multicast source is local to the plurality of local clients, providing to the plurality of local clients, local access to the local multicast source.

According to another aspect, the invention provides for a system wherein local access comprises access only through the local network.

According to another aspect, the invention provides for a system wherein the registration comprises a unique identifier for identifying the nonlocal streaming resource.

According to another aspect, the invention provides for a system wherein the registration comprises one of an address and locator information of the local multicast source for providing local access by the plurality of local clients to the local multicast source.

According to another aspect, the invention provides for a system wherein the local multicast source is a local IP multicast source.

According to another aspect, the invention provides for a system wherein the nonlocal server is for registering the local resource by: receiving the unique identifier of the nonlocal streaming resource in a resource register message; and storing the unique identifier in the registry.

According to another aspect, the invention provides for a system wherein the one of an address and locator information of the local multicast source is explicit, and wherein the resource management server is for registering the local multicast source by storing the one of an address and locator information of the local multicast source in the registration with the unique identifier of the nonlocal streaming resource.

According to another aspect, the invention provides for a system wherein the registration and redirection module determines that the local multicast source corresponds to the nonlocal streaming resource of the plurality of requests with use of the registration by comparing unique identifiers of entries in the registry with information in the plurality of requests identifying the nonlocal streaming resource.

According to another aspect, the invention provides for a system wherein the registration and redirection module determines that the local resource is local to the local client by comparing one of an implicit address and implicit locator information contained within communication signals from a local source of the local resource with a corresponding one of an implicit address and implicit locator information contained within communication signals from the local client.

According to another aspect, the invention provides for a system wherein the resource management server provides to the plurality of local clients, local access to the local multicast source by sending a plurality local redirection messages to the plurality of local clients wherein each of the local redirection messages comprises information sufficient to enable local access to the local multicast source by each of the plurality of local clients.

According to another aspect, the invention provides for a system wherein each of the local redirection messages comprises at least one of an explicit address and explicit locator information which enables local access to the local multicast source.

According to another aspect, the invention provides for a system wherein the nonlocal streaming resource comprises streaming media.

According to another aspect, the invention provides for a system for reducing a bandwidth and storage consumed in a process of managing video, wherein the local network comprises a corporate network, wherein the process of managing video is carried out on the corporate network, and wherein the nonlocal streaming resource comprises video managed by the process of managing video.

According to another aspect, the invention provides for a system wherein at least one local client of the plurality of local clients comprises a security application and the nonlocal streaming resource comprises a security video stream for use by the security application.

According to another aspect, the invention provides for a system for one of re-purposing and multi-purposing the nonlocal streaming resource in the form of a camera stream, wherein the local network comprises a corporate network, wherein the camera stream is used for a primary purpose, and wherein at least one local client of the plurality of local clients utilizes the camera stream for a secondary purpose different from the primary purpose.

According to another aspect, the invention provides for a system wherein said local access comprises delayed access.

According to another aspect, the invention provides for a system wherein the local server stores a local copy of the nonlocal streaming resource.

### BRIEF DESCRIPTION OF THE DRAWINGS

The features and advantages of the invention will become more apparent from the following detailed description of the preferred embodiment(s) with reference to the attached figures in which like features bear similar labels, and wherein:

FIG. 1 is a network diagram illustrating a known system for network resource delivery providing access to multiple clients;

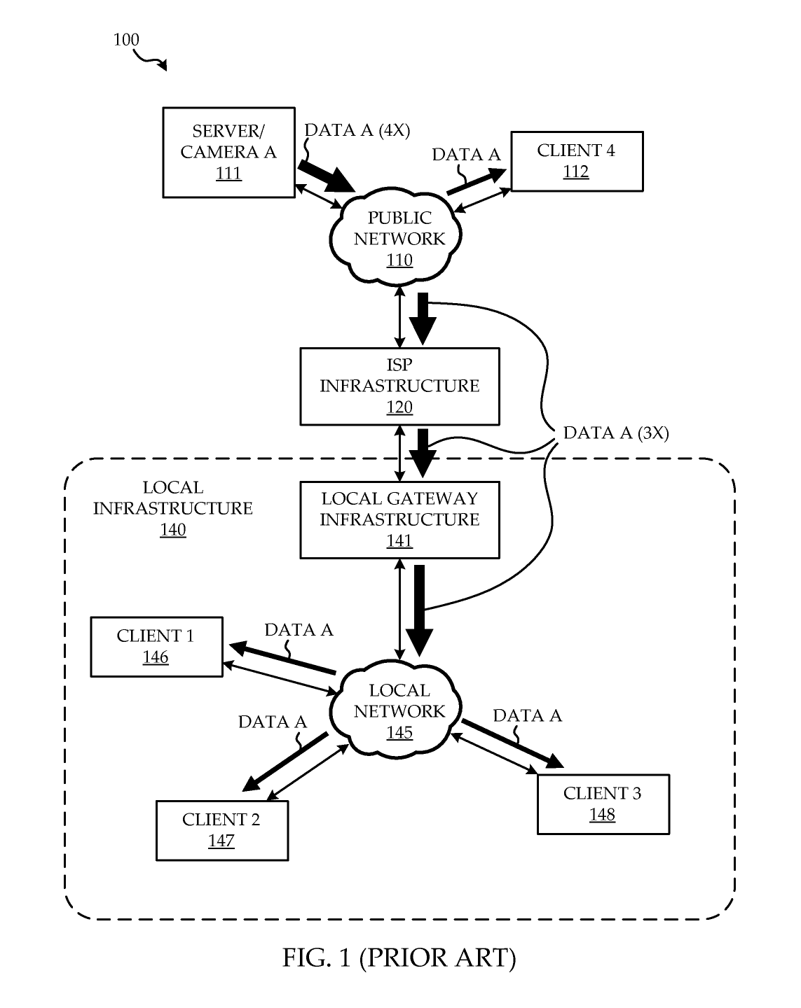

FIG. 2A is a network diagram illustrating an initialization phase for a system for network resource delivery to multiple local clients according to an embodiment of the invention;

FIG. 2B is a network diagram illustrating a delivery phase for the system for network resource delivery depicted in FIG. 2A;

FIG. 3A is a message diagram illustrating communications exchanged between various elements of the system depicted in FIG. 2A and FIG. 2B during initialization and resource delivery according to an embodiment of the invention;

FIG. 3B is a message diagram illustrating communications exchanged between various elements of the system depicted in FIG. 2A and FIG. 2B during initialization and resource delivery according to another embodiment of the invention; and

FIG. 4 is a functional block diagram illustrating a method of providing local multicasting of a single external streaming source according to an embodiment of the invention.

### DETAILED DESCRIPTION OF THE PREFERRED EMBODIMENTS

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

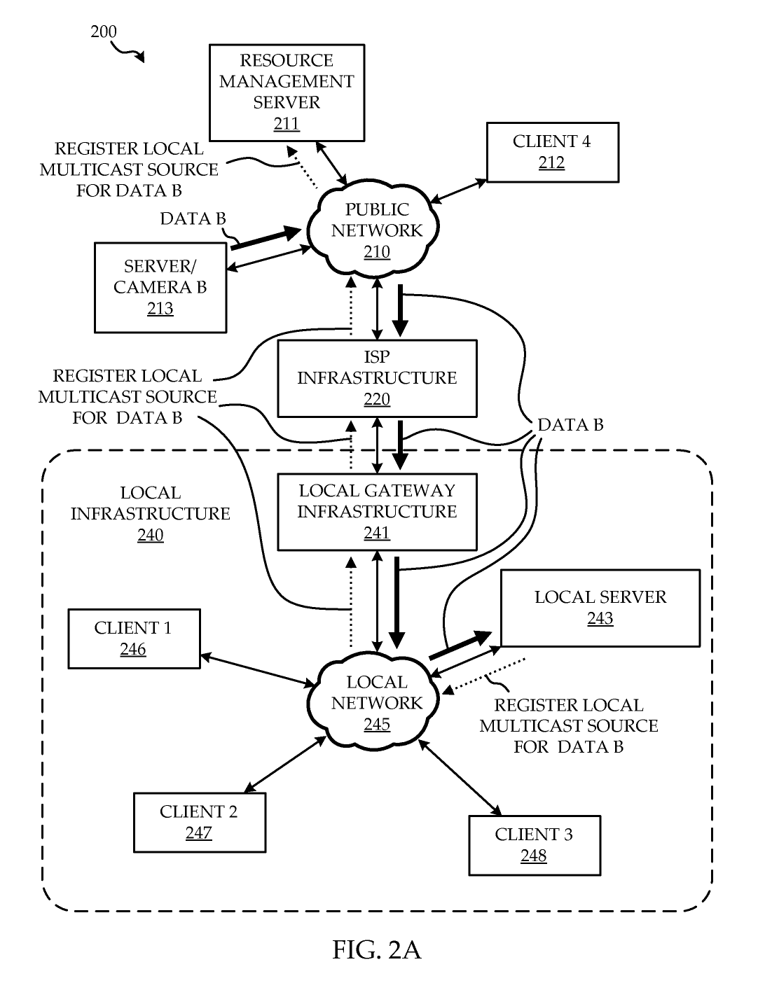

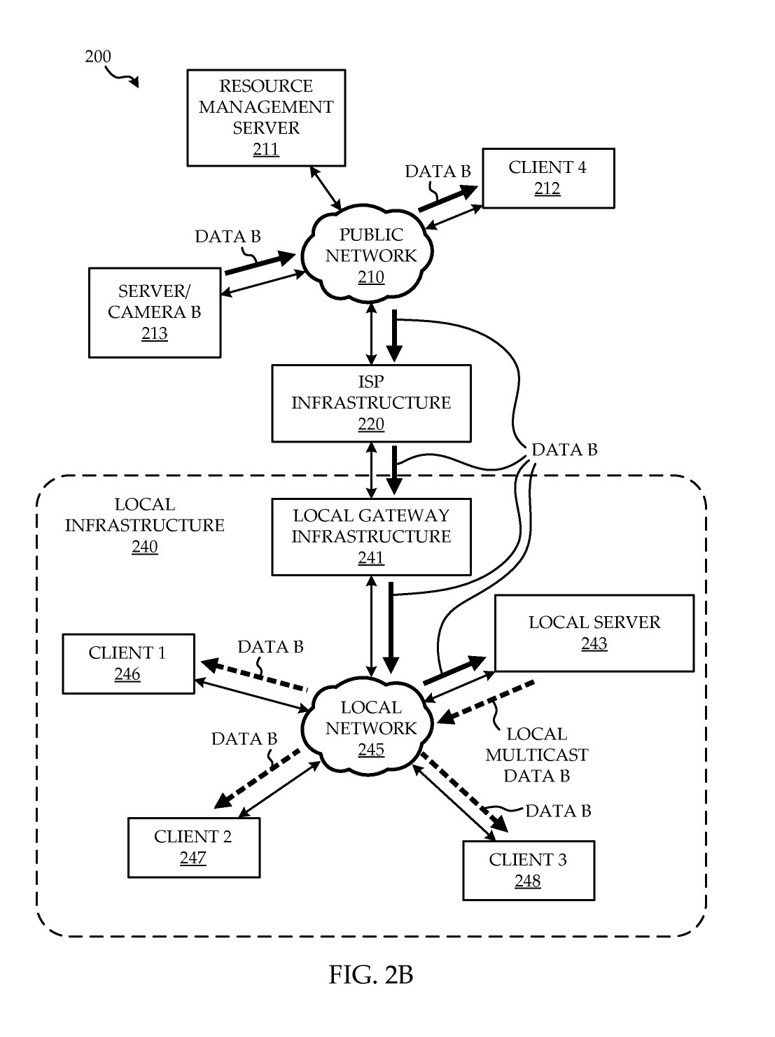

Referring to FIG. 2A, a system 200 for network resource delivery to multiple local clients according to an embodiment of the invention will now be discussed. In the embodiment depicted in FIG. 2A, nonlocal streaming resource DATA B is available from a nonlocal source server 213 and is further made available to local clients during their sessions with a nonlocal resource management server 211. As is discussed hereinbelow, in FIG. 2A the system 200 is performing an initialization phase for setting up of a local multicast source providing a locally multicast resource replicated from the nonlocal resource DATA B and registration thereof for delivery of DATA B to multiple local clients.

The system 200 will first be discussed in terms of structure. Three local clients, a first local client 246 (CLIENT 1), a second local client 247 (CLIENT 2), and a third local client 248 (CLIENT 3) are all connected to a local network 245 which also includes a local server 243 and a host of other local clients, servers, and network infrastructure (not shown) forming local infrastructure 240. For the embodiment depicted in FIG. 2A, the local infrastructure 240 is the network infrastructure servicing the premises of a hotel or convention center while the local clients 246, 247, 248 are local desktops or laptops capable of accessing and displaying streaming video. For access to outside networks, a local gateway infrastructure 241, which is also connected to the local network 245, is used. The local gateway infrastructure 241 facilitates, manages, and possibly monitors communications leaving and entering the local network 245 from an exterior of the local infrastructure 240.

The local gateway infrastructure 241 is connected by an Internet service provider (ISP) infrastructure 220 to a large public network 210 such as the Internet. Although numerous machines, clients, and servers may form part of and are connected to the large public network 210, for convenience only a nonlocal source server 213, a nonlocal resource management server 211, and a nonlocal client 212 (CLIENT 4) are shown connected to the large public network 210.

The system 200 depicted in FIG. 2A will now be described in terms of its function during an initialization phase of its operation in delivering resource DATA B to multiple destinations.

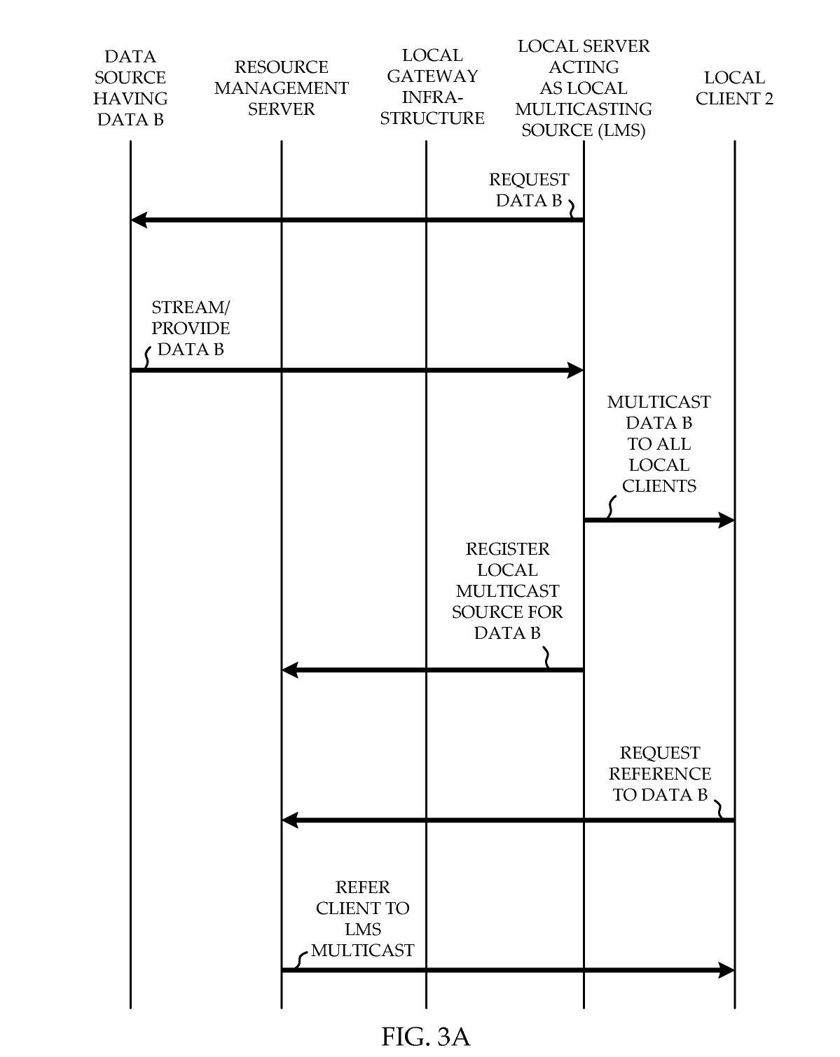

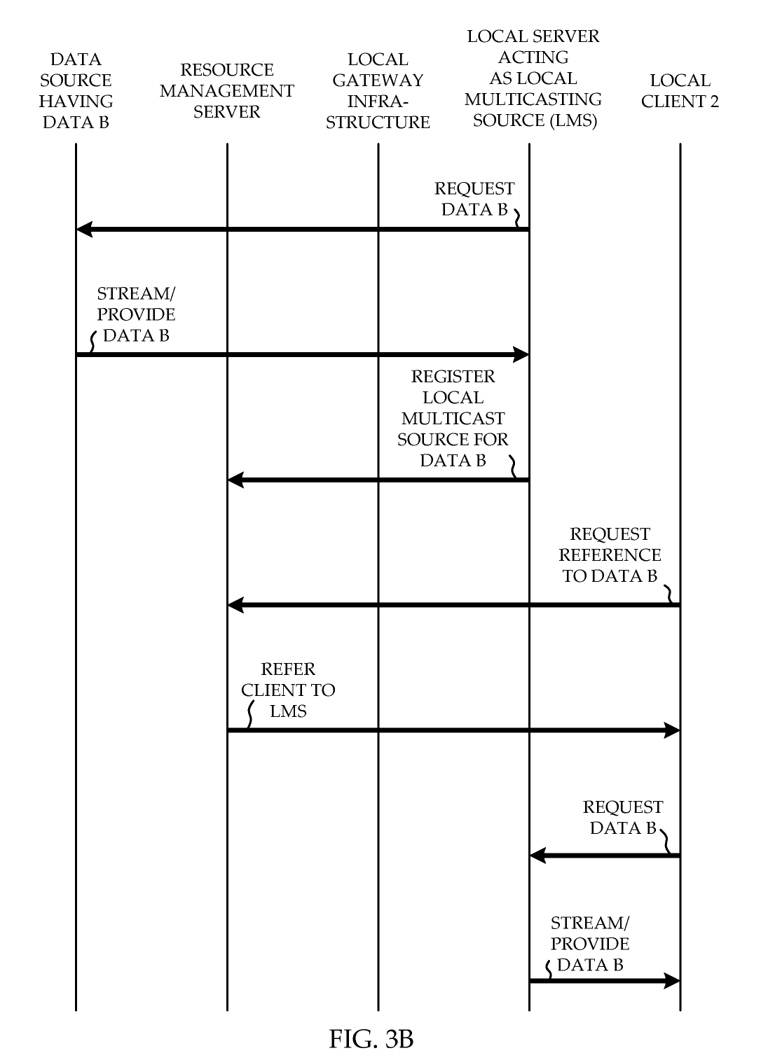

The local server 243 makes a standard request for DATA B utilizing a URL, IP address, or other address. Referring also to FIG. 3A, the nonlocal source server 213 begins to stream or otherwise provide DATA B. Once the local server 243 begins to receive the streaming resource DATA B from the nonlocal source server 213, the local server 243 replicates the streaming resource DATA B forming of a local multicast source for DATA B for access by other clients of the local infrastructure 240. In a specific embodiment depicted in FIGS. 2A and 2B, DATA B is provided by the local server 243 in the form of an IP multicast of the streaming resource DATA B originally provided by the nonlocal source server 213. In order for this local multicast source to be known to other clients in the local infrastructure 240 for access, the local server 243 sends a register DATA B registration message to the resource management server 211. The registration message contains a unique identifier of the resource DATA B, and an address or locator information for providing access to the local multicast source for DATA B that the local server 243 is providing. The registration message arrives at the resource management server 211 which processes the registration message and stores the registration information for later use.

Registration and conversely deregistration may take place on a one-time event triggered basis, namely, when the local multicast source is first made available or conversely when it is removed or otherwise made unavailable.

Once the local server 243 has registered its local multicast source for DATA B on the resource management server 211, the streaming resource DATA B being received by the local server 243 from the nonlocal source server 213 is available for access by local clients of the local infrastructure 240 in the manner described below.

Referring now also to FIG. 2B, the system 200 will now be described in terms of its function during a delivery phase of its operation in delivering resource DATA B to multiple destinations.

Each of the first, second, and third local clients 246, 247, 248 sends a request for DATA B through the local network 245, the local gateway infrastructure 241, the ISP infrastructure 220, and the large public network 210 to the resource management server 211. Each request for DATA B includes a unique identifier identifying DATA B as the requested resource. For illustrative purposes one can envisage the local clients being used by individuals, each a guest, on New Year's Eve, of the same five star hotel in New Jersey, each who is too busy to take part in the evening's festivities but who wish, nonetheless, to watch a live streaming video of the ball drop in Time Square, for a full minute leading up to and including the countdown to the new year. Upon receiving the requests for DATA B from the local clients 246, 247, 248, the resource management server 211 checks its registry (not shown) for an entry corresponding to DATA B and containing information for access to the resource DATA B. The resource management server 211 finds an entry in the registry identifying resource DATA B, and containing an address or locator information for enabling access to DATA B in the form of the local multicast source on the local server 243 through the local network 245. Using implicit or inherent address or locator information contained within the communications signals between the resource management server 211 and each of the local server 243 and the local clients 246, 247, 248, the resource management server 211 determines that the local server 243 and the local clients 246, 247, 248 are local to each other and are both part of the local network 245. In some embodiments, the resource management server 211, in addition to analyzing the implicit or inherent address or locator information, analyzes the explicit address or locator information provided in the entry in the registry to establish that the local server 243 and the local clients 246, 247, 248 are local to each other. Since DATA B is being multicast from the local server 243 within the local network 245 which is local to the local clients 246, 247, 248, the resource management server 211 replies to the request for DATA B with a local redirect message which passes through the large public network 210, the ISP infrastructure 220, the local gateway infrastructure 241, and the local network 245 and arrives at the local clients 246, 247, 248. The local redirect message indicates to the local clients 246, 247, 248 that the requested resource DATA B is being multicast locally within the local network 245 and moreover provides the explicit address or locator which was registered, this explicit address or locator being sufficient for enabling the local clients 246, 247, 248 to directly access through the local network 245 the local multicast source for DATA B from local server 243.

As can be seen in FIG. 2B, the final result is the multicasting of DATA B from the local server 243 as the local server 243 receives DATA B from the nonlocal source server 213.

Referring also to FIG. 3B, in an alternative embodiment, once the local client 243 registers the availability of the local multicast source for DATA B, the local multicast source does not proceed to multicast immediately. Instead, the local client 243 refrains from multicasting or otherwise streaming DATA B to other clients unless and until a request for DATA B from such another client is received. In some embodiments, the local client 243 stores DATA B for delayed multicast.

Since the streaming video resource provided in the form of the local multicast source is not duplicated and streamed multiple times through the public network 210, ISP infrastructure 220, local gateway infrastructure 241, unnecessary bandwidth, resources and hence unnecessary power and cost are avoided. Local infrastructure 240, also benefits from an overall reduced bandwidth and storage requirements in the delivery of DATA B. During peak broadcast times and special events, bandwidth and network utilization savings from a local infrastructure 240 having N clients requesting the same external streaming resource is on the order of (N-1) times the bandwidth and resources required to deliver a single stream of that same streaming resource.

Although in the embodiments described hereinabove the element providing the local multicast source, namely the local server 243, is described as a server, it is to be understood that the local server 243 may also be a client in the sense that it may itself be capable of receiving and displaying streaming video to an individual user, as well as capable of providing a multicast source for that same streaming video. In some embodiments a number of clients of the local network are capable of receiving and displaying streaming video as well as serving as a multicast source of that same streaming video for other clients to access.

It should be understood, that in each of the embodiments described hereinabove and with any combination of the features thereof, the requested resource DATA B may be only one amongst many resources requested by one or more local applications running on any one of the local clients 246, 247, 248. Local client 245 may be running one or more Internet applications which may be displaying information and/or content from various sources at once, for example, one of our New Jersey guests may be watching Time Square in one frame of a webpage while watching security camera video streams in a second frame of a webpage, displaying a blog in another frame, downloading a sports RSS feed, while streaming and playing audio from a web-radio station in the background.

In another nonlimiting example application of the use of the system 200 depicted in FIG. 2A and FIG. 2B, the local clients 246, 247, 248 are running video security applications which accesses streamed video security feeds managed by the resource management server 211. In some embodiments the video security application is a stand-alone application while in other embodiments the video security application is a web enabled application executed within a web browser. The local clients 246, 247, 248 have an identification of a resource, which identifies the video camera, source, or server, from which the local clients 246, 247, 248 are requesting a video security feed and which corresponds to a data resource (DATA B) generated thereby. In this case the security feed may be a video stream of specific entranceways to the hotel lobby and shops, which on New Year's Eve may require extra live monitoring by specially trained personnel. The identification of the resource uniquely identifies either the provider or the feed itself but does not in general enable the local clients 246, 247, 248 direct access. As with the embodiments described above, once any local server has registered its local multicast source for the video security feed, the resource management server 211 which already has a registration of the video security feed, determines that the clients are local to and require access to the local multicast source for the video security feed and returns to the clients the address required for that access.

It should be noted that although the embodiments described hereinabove show each stream of the multicast source being delivered to different recipient users, DATA B may be multicast to a number of different destinations or systems which may be owned by the same entity. In these embodiments, each copy of the stream is used by each different system running a different application for a different purpose. Examples of this include corporations or businesses which own cameras already providing video for one purpose, for example, security, but which use the same video for other purposes. So called repurposing can save large amounts of cost in terms of bandwidth, infrastructure, equipment, storage etc. In a non-limiting example, security feeds may be re-purposed for equipment and building maintenance, customer profiling marketing research, and employment management. Further cost savings are achieved by combining the re-purposing of video streams with the savings attained by the system and method of resource replication described hereinabove

In some embodiments the nonlocal source server 213 comprises a computer and associated camera while in others, the camera itself comprises sufficient digital processing to enable it to serve as the nonlocal source server 213.

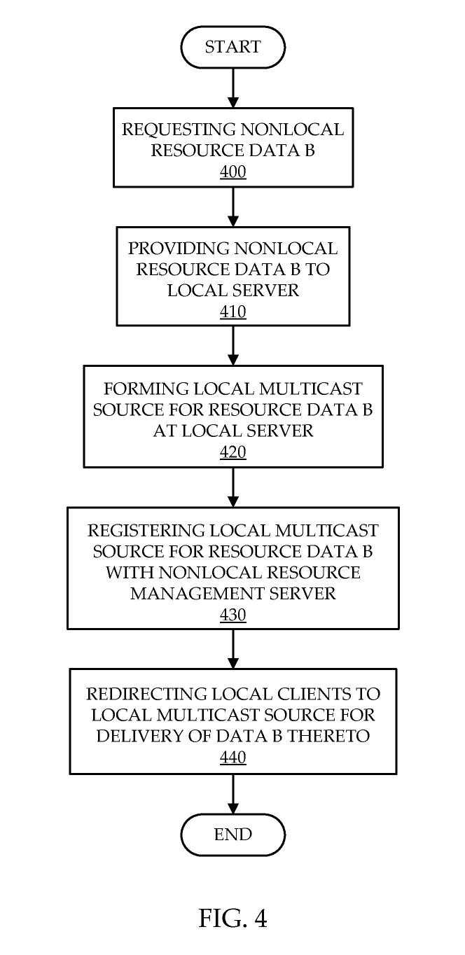

Referring to FIG. 4, a method for network resource delivery according to an embodiment of the invention will now be discussed.

At step 400 streaming nonlocal resource DATA B is requested by a local server. At step 410, the nonlocal resource DATA B is provided to the local server. As and when the local server receives the nonlocal resource DATA B stream, the local server provides the same for access by local clients by forming a local multicast source for resource DATA B at the local server in step 420. Once the local multicast source is available, a registration of the local multicast source for DATA B is generated and is registered with a nonlocal resource management server at step 430. As was described hereinabove the registration of the local multicast source for resource DATA B includes a unique identifier identifying the resource DATA B and may also contain an explicit address or locator information. The resource management server, upon receiving the registration, stores it in its registry. In the event that a local client requester requests resource DATA B, the resource management server receives the request for the resource from the local client requester and at step 440 the resource management server searches its registry, identifies that the requested resource has been replicated and is available in a local multicast form and establishes with use of inherent or explicit address and locator information that the local multicast source and the local client are local to each other and either sends the local client or a local gateway infrastructure the explicit or respectively inherent address and locator information thereby enabling redirection of the local requester to the local multicast source for access to the resource DATA B.

Each of the embodiments described above mitigates the use of resources external and internal to the local network when providing access to a nonlocal resource, via local replication of the nonlocal resource in the form of a local multicast source, to a number of local clients requesting the same streaming resource. This mitigates undesirable delay and needless costs and use of hardware recourses since the data or resource requested by the local clients is provided as a multicast source residing within the local network, and hence multiple copies need not be retrieved or sent though various parts of the system.

Although example applications of the embodiments have been described, it should be understood that the local server 243 may be providing a multicast of any type of streaming media, or alternatively derivative streaming data, which may have originally been audio or video but may now comprise information regarding an analysis or security analytics process exercised thereon. As stated hereinabove it should be understood that regardless of the form of the data or what part of the security data processing/delivery path the method or system is applied to, replication of a nonlocal source in the form of a local multicast source, registration and delivery of the data thereof may be provided by the method or system as described hereinabove.

Although the specific embodiments have been described as including a specific kind of multicast source within the local network, it should be understood that the invention may be practiced with any mechanism which provides multiple local access to the nonlocal streaming resource. Example embodiments in which the nonlocal streaming resource is otherwise provided to the local clients include among others, access via a ring network structure, access via Ethernet or other local broadcast, and gateway or router duplication/replication of the nonlocal streaming resource as it enters the local network. In these embodiments, instead of each registration identifying a local multicast source, it identifies the local availability of the nonlocal streaming resource to local clients in whatever form that local availability takes.

Although the embodiments described hereinabove appear to be examples of static systems, it should be understood that local server 243 may be a mobile multicast source which may have originally been a nonlocal source providing DATA B over a WiFi connection to, for example, a WAN wireless cell network, which upon crossing into, for example, an area covered wirelessly by a wireless local network, becomes the local server 243 which is now capable of serving as a local multicast source.

The embodiments presented are exemplary only and persons skilled in the art would appreciate that variations to the embodiments described above may be made without departing from the spirit of the invention. The scope of the invention is solely defined by the appended claims.

What is claimed is:

1. A method of providing access to a nonlocal streaming resource within a local network, the method comprising:
receiving the nonlocal streaming resource at a local server in the local network;
replicating the nonlocal streaming resource and forming a local multicast source of the nonlocal streaming resource;
registering the local multicast source on a resource management server, generating a registration;
receiving at the resource management server a plurality of requests for the nonlocal streaming resource from a corresponding plurality of local clients of the local network;
determining that the local multicast source corresponds to the nonlocal streaming resource of the plurality of requests with use of the registration;
determining that the local multicast source is local to the plurality of local clients; and
providing to the plurality of local clients, local access to the local multicast source.

2. A method according to claim 1 wherein local access comprises access only through the local network.

3. A method according to claim 2 wherein the registration comprises a unique identifier for identifying the nonlocal streaming resource.

4. A method according to claim 3 wherein the registration comprises one of an address and locator information of the local multicast source for providing local access by the plurality of local clients to the local multicast source.

5. A method according to claim 4 wherein forming the local multicast source comprises creating a local IP multicast source for the nonlocal streaming resource.

6. A method according to claim 4 wherein registering the local multicast source comprises:
receiving at the resource management server the unique identifier of the nonlocal streaming resource in a resource register message; and
storing the unique identifier in an entry of a registry.

7. A method according to claim 6, wherein the one of an address and locator information of the local multicast source is explicit, and wherein registering the local multicast source further comprises storing the one of an address and locator information of the local multicast source in the registration with the unique identifier of the nonlocal streaming resource.

8. A method according to claim 6, wherein determining that the local multicast source corresponds to the nonlocal streaming resource of the plurality of requests with use of the registration comprises comparing unique identifiers of entries in the registry with information in the plurality of requests identifying the nonlocal streaming resource.

9. A method according to claim 4, wherein determining that the local multicast source is local to the plurality of local clients comprises comparing one of an implicit address and implicit locator information contained within communication signals of the local multicast source with a corresponding one of an implicit address and implicit locator information contained within communication signals from the plurality of local clients.

10. A method according to claim 4, wherein providing to the plurality of local clients, local access to the local multicast source comprises sending a plurality of local redirection messages from the resource management server to the plurality of local clients wherein each of the local redirection messages comprise information sufficient to enable local access to the local multicast source by each of the plurality of local clients.

11. A method according to claim 10, wherein each of the local redirection messages comprises at least one of an explicit address and explicit locator information which enables local access to the local multicast source.

12. A method according to claim 4 wherein the nonlocal streaming resource comprises streaming media.

13. A method according to claim 1 for reducing a bandwidth and storage consumed in a process of managing video, wherein the local network comprises a corporate network, wherein the process of managing video is carried out on the corporate network, and wherein the nonlocal streaming resource comprises video managed by the process of managing video.

14. A method according to claim 12 wherein at least one of the plurality of local clients comprises a security application and the nonlocal streaming resource comprises a security video stream for use by the security application.

15. A method according to claim 1 for at least one of re-purposing and multi-purposing the nonlocal streaming resource in the form of a camera stream, wherein the local network comprises a corporate network, wherein the camera stream is used for a primary purpose, and wherein at least one local client of the plurality of local clients utilizes the camera stream for a secondary purpose different from the primary purpose.

16. A method according to claim 1 wherein said local access comprises delayed access.

17. A method according to claim 1 wherein the local server stores a local copy of the nonlocal streaming resource.

18. A system for providing access to a nonlocal streaming resource within a local network, the system comprising:
a local server in the local network for receiving the nonlocal streaming resource, for replicating the nonlocal streaming resource, and for forming a local multicast source of the nonlocal streaming resource;
a resource management server for registering the local multicast source thereby generating a registration and for receiving a plurality of requests for the nonlocal streaming resource from a plurality of local clients of the local network, the resource management server comprising:
a registry for storing the registration; and
a registration and redirection module for determining that the local multicast source corresponds to the nonlocal streaming resource of the plurality of requests with use of the registration, and for determining that the local multicast source is local to the plurality of local clients,
wherein the resource management server is for, once the registration and redirection module determines that the request is for the nonlocal streaming resource corresponding to the local multicast source and that the local multicast source is local to the plurality of local clients, providing to the plurality of local clients, local access to the local multicast source.

19. A system according to claim 18 wherein local access comprises access only through the local network.

20. A system according to claim 19 wherein the registration comprises a unique identifier for identifying the nonlocal streaming resource.

21. A system according to claim 20 wherein the registration comprises one of an address and locator information of the local multicast source for providing local access by the plurality of local clients to the local multicast source.

22. A system according to claim 21 wherein the local multicast source is a local IP multicast source.

23. A system according to claim 21 wherein the nonlocal server is for registering the local resource by:
receiving the unique identifier of the nonlocal streaming resource in a resource register message; and
storing the unique identifier in the registry.

24. A system according to claim 23, wherein the one of an address and locator information of the local multicast source is explicit, and wherein the resource management server is for registering the local multicast source by storing the one of an address and locator information of the local multicast source in the registration with the unique identifier of the nonlocal streaming resource.

25. A system according to claim 23, wherein the registration and redirection module determines that the local multicast source corresponds to the nonlocal streaming resource of the plurality of requests with use of the registration by comparing unique identifiers of entries in the registry with information in the plurality of requests identifying the nonlocal streaming resource.

26. A system according to claim 22, wherein the registration and redirection module determines that the local resource is local to the local client by comparing one of an implicit address and implicit locator information contained within communication signals from a local source of the local resource with a corresponding one of an implicit address and implicit locator information contained within communication signals from the local client.

27. A system according to claim 21, wherein the resource management server provides to the plurality of local clients, local access to the local multicast source by sending a plurality local redirection messages to the plurality of local clients wherein each of the local redirection messages comprises information sufficient to enable local access to the local multicast source by each of the plurality of local clients.

28. A system according to claim 27, wherein each of the local redirection messages comprises at least one of an explicit address and explicit locator information which enables local access to the local multicast source.

29. A system according to claim 21 wherein the nonlocal streaming resource comprises streaming media.

30. A system according to claim 18 for reducing a bandwidth and storage consumed in a process of managing video, wherein the local network comprises a corporate network, wherein the process of managing video is carried out on the corporate network, and wherein the nonlocal streaming resource comprises video managed by the process of managing video.

31. A system according to claim 29 wherein at least one local client of the plurality of local clients comprises a security application and the nonlocal streaming resource comprises a security video stream for use by the security application.

32. A system according to claim 18 for one of re-purposing and multi-purposing the nonlocal streaming resource in the form of a camera stream, wherein the local network comprises a corporate network, wherein the camera stream is used for a primary purpose, and wherein at least one local client of the plurality of local clients utilizes the camera stream for a secondary purpose different from the primary purpose.

33. A system according to claim 18 wherein said local access comprises delayed access.

34. A system according to claim 18 wherein the local server stores a local copy of the nonlocal streaming resource.
